(19) United States
(12) Patent Application Publication
(10) Pub. No.: US 2006/0195991 A1
(43) Pub. Date: Sep. 7, 2006

(54) Transport cleaning device

(76) Inventor: Alexander J.G. Baumhakel, Lebring (AT)

Correspondence Address: COHEN & GRIGSBY, P.C., 11 STANWIX STREET, 15TH FLOOR, PITTSBURGH, PA, 15222, US

(21) Appl. No.: 11/126,419

(22) Filed: May 11, 2005

Related U.S. Application Data
(60) Provisional application No. 60/569,966, filed on May 11, 2004.

(51) Int. Cl. A47L 9/04; A47L 11/24; A47L 11/28; A47L 11/30; B08B 7/00

(52) U.S. Cl. 15/49.1; 15/320; 15/384; 15/50.1; 134/6

(57) ABSTRACT

A device for removing waste from a surface includes a housing, first and second agitators rotateably attached to the housing, each having an arcuate surface area and rotation in opposite direction. A third agitator is located between the first and second agitators, the third agitator having an arcuate surface area and a counterclockwise rotation. The first agitator transports waste to the second agitator which in conjunction with the third agitator projects debris into a waste container. A method of using the device to remove debris from a surface is also described.

This application claims priority to U.S. Provisional Application No. 60/569,966 filed on May 11, 2004.

### FIELD OF THE INVENTION

The present invention relates to a device for cleaning various surfaces and, in particular, relates to a cleaning device having three aligned cylindrical agitators which can be manually driven, moved, or self propelled over variously leveled hard or soft surfaces to collect waste particles, liquids and/or chemical cleaning products.

### BACKGROUND OF THE INVENTION

Cleaning floors and other pedestrian surfaces is well known. In recent years, cleaning pedestrian surfaces has become a complex combination of making certain such surfaces are clean and doing so in the most expeditious manner. The cost of labor has placed a premium on the development of both new cleaning processes and chemicals, as well as on machines that clean in one rather than multiple passes.

Many devices have been developed for removing dirt and debris or liquids from vertical and horizontal surfaces. Typically, cleaning devices employ rotating brushes in combination with suction for the collection of waste, such as with a vacuum cleaner. Other devices utilize brushes having bristled bodies that are swivelably mounted on a member for sweeping. Street sweepers, for example, are commonly provided with an intake broom and suction carriage that collect and transmit the suctioned waste to a hopper. A few devices use belts or drums as a transport tool to remove and collect waste. However, such devices tend to be susceptible to abrasion and wear, work on limited types of surfaces, and have compromised efficiencies. Some of these devices are capable of applying and removing cleaning solutions from a carpet or hard surface to accomplish chemical cleaning.

For commercial and large public floors, some of the most common high efficiency cleaning machines incorporate the use of one or two cylindrical brushes which are mounted to rotate at high revolutions per minute to lift and deposit the debris in removable containers. These newer devices operate on hard surfaces such as concrete, wood, marble, and tile, as well as softer surfaces such as mats and carpeting of various pile depths and stiffness. Some of these prior art cleaning machines, utilizing one or two cylindrical rotating brushes, work with dry cleaning chemicals by agitating the chemicals into and out of the carpet or surface and into a hopper for disposal. Others utilize liquid cleaning tanks to dispense cleaning agents on the surface either by a sprayer or through the rotating brushes themselves.

### OBJECTS AND SUMMARY OF THE INVENTION

While many of these known cleaning machines are adequate for small commercial applications, they do not provide the efficiencies and cleaning capabilities to adequately handle large commercial spaces and public facilities. Accordingly, in an example it is an object of the present invention to provide a cleaning device that is useful on carpeting as well as other types of surfaces and applications to provide increased efficiencies and cleaning capabilities.

It is a further object in an embodiment of the invention to provide a cleaning device that can provide reduced cleaning costs for large commercial floors and public pedestrian ways and buildings.

It is another object in an embodiment of the invention to provide a cleaning device that can remove soil and debris from a surface quickly.

It is another object in an embodiment of the invention to provide a cleaning device that has at least one agitator that may also work to propel the device along the surface to be cleaned.

It is yet a further object in an embodiment of the invention to provide a rotating agitator system that efficiently and effectively collects waste from any type of indoor or outdoor surface, or any vertical, horizontal, or sloped surface, without the need for a vacuum or other mechanical belt means to remove the debris from the surface being cleaned.

It is yet another object in an embodiment of the invention to provide an improved cleaning device that utilizes a rotating arcuate surface area to collect and remove waste from surfaces having irregularities, such as texture.

It is yet another object in an embodiment of the invention to provide a cleaning device having a waste container that is easy to handle and replaceable, unlike prior art devices that use vacuum cleaner bags that can be a challenge to attach and require frequent replacement.

The present invention is directed to a device for removing debris from a surface, comprising a housing and first and second cylindrical agitators rotatably attached thereto. Each of the first and second agitators has an arcuate contact surface area for contact with the surface to be cleaned. The first agitator has a first direction of rotation and the second agitator has a second direction of rotation that opposes the first direction of rotation. In a preferred embodiment, first and second agitators rotate towards each other to direct debris inward to where it can be removed from the surface to be cleaned. Preferably, the first agitator has a counterclockwise rotation and the second agitator has a clockwise rotation. The invention further comprises a third agitator that is interposed between the first and second agitators and rotates in the same direction as the first agitator. Preferably, the third agitator is more proximate to the second agitator. The third agitator has an arcuate surface contact area and a diameter that is preferably smaller than the diameter of either the first or second agitators.

In the present invention, the first agitator transports debris to the second agitator, and the second agitator, in conjunction with the third agitator, transports the debris away from the surface. Preferably, it is transported into a hopper or waste container. The employment of the third agitator provides unique advantages in the efficiency of the device, both in the removal of dirt and debris from the surface to be cleaned, as well as the required number of passes over such debris, to reduce the time required to clean a surface. Additionally, the third agitator may also work to assist in propelling the device along the surface to be cleaned.

Transport wheels may be used to support or transport the device when not in use. Transport wheels may be adjustably retractable to permit raising and lowering the agitators from and to the surface to be cleaned. The agitators substantially support the device when the transport wheels are retracted. When the transport wheels are fully extended for transport or storage, the wheels substantially support the weight of the device. In an embodiment, the transport wheels are adjusted to a mid-point so that the transport wheels and the agitators carry the weight of the device together.

The device can be used to clean a variety of surfaces, both indoor and outdoor, and horizontal, vertical, or sloped. For example, the device may be used to clean floors, floor surfaces of a variety of materials, walls, carpet, brick, stone, grouted tile, wood, tile, vinyl, rubber, concrete, pavement, or asphalt surfaces, or a combination thereof, as well as such surfaces as escalators and conveyor belts.

The present invention represents a substantial advance over prior art cleaning devices by providing a unique means for removing and transporting dirt and debris from the surface to be cleaned, wherein the removal and transport means are substantially more efficient and effective than conventional two-brush cleaning machines of the prior art. Further benefits from the invention entail not only the removal of typical cleaning solutions and dirt, but also large and small waste items such as papers, washers, nails, sand, and cigarette ashes from the surface. The removal is substantially continuous without repetitive motion on both flat and irregular surfaces such as bricks, slate and the like.

Those and other details, objects, and advantages of the present invention will become better understood or apparent from the following description and drawings showing embodiments thereof.

### BRIEF DESCRIPTION OF THE DETAILED DRAWINGS

The accompanying drawings illustrate examples of embodiments of the invention. In such drawings:

FIG. 1 shows a cutaway of a side view of an example of an embodiment of the present invention with the transport wheels in a retracted position for cleaning a surface.

FIG. 2 shows a cutaway of a side view of an example of an embodiment of the present invention with the transport wheels fully extended for transport or storage.

FIG. 3 shows a cutaway of a side view of an example of an embodiment of the present invention as configured in combination with a waste container, showing the lid to the waste container as partially open.

FIG. 4 shows a schematic of an embodiment of the drive means and drive gears of the present invention.

FIG. 5 shows a cutaway of a side view of an example of an embodiment of the present invention as configured in combination with a waste container having a mouth for use in combination with suction.

FIG. 6 shows a cutaway of a side view of an example of an embodiment of the present invention as configured in combination with a waste container having a mouth connected to a vacuum hose.

FIG. 7 shows a cutaway of a side view of an example of an embodiment of the present invention as configured in combination with a filter bag.

FIG. 8 shows a bottom view of an embodiment of an example of the present invention.

FIG. 9 shows a top view of an embodiment of an example of the present invention.

FIG. 10 shows a side view of an embodiment of an example of the present invention as configured in combination with a waste container.

FIG. 11 shows a side view of an example of an embodiment of the present invention as configured in combination with a waste container having a mouth.

### DETAILED DESCRIPTION OF EXAMPLES OF THE INVENTION

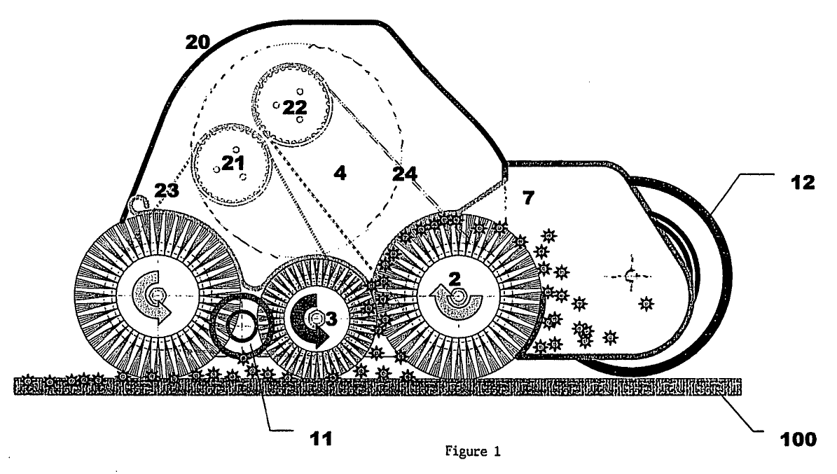

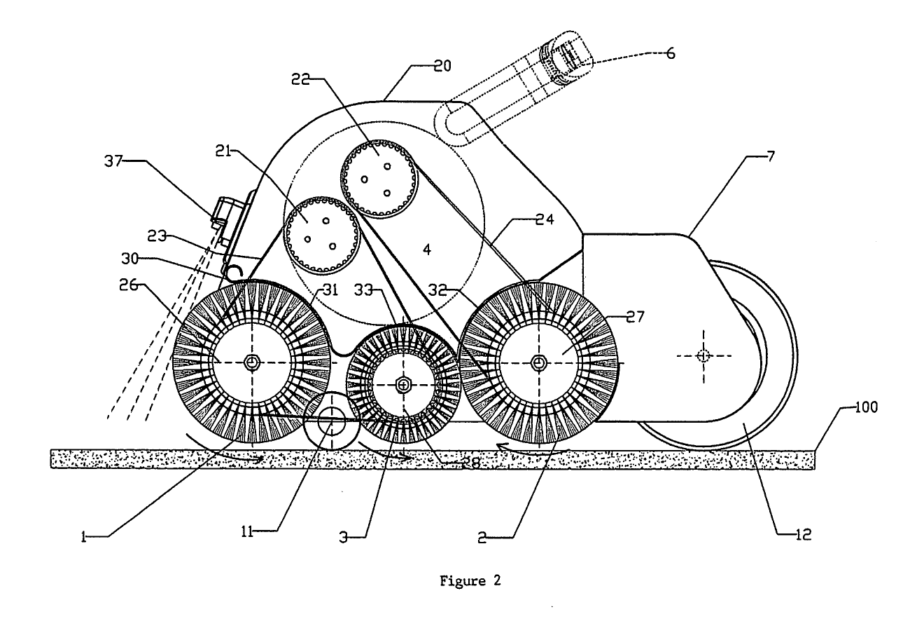

FIGS. 1 and 2 show cutaway side views of embodiments of the present invention. As shown in the figures, and referring particularly to FIGS. 1 and 2, there is a housing 20 to which first, second, and third cylindrical agitators 1, 2, 3, are rotatably attached. Although many of the figures show the agitators 1, 2, 3 as being bristled-brushes, it should be appreciated that the drawings are not intended to be limiting and that the present invention may use any sort of agitator suitable for cleaning surfaces. Agitators include those that agitate and those that do not, including brushes, bristled-rollers such as conventional bristled-rollers, rollers, rollers with recesses or indentations, rollers with projections, and combinations thereof. Each agitator 1, 2, 3 has an arcuate contact surface area for contact with the surface to be cleaned. The third agitator 3 is preferably interposed between the first and second agitators 1, 2. Preferably, third agitator 3 is positioned in substantially closer proximity to second agitator 2 than to first agitator 1. In an embodiment, second and third agitators substantially touch, and in another embodiment, second and third agitators 2, 3 nearly touch, although the agitators 2, 3 may be positioned with a distance between them that is up to 20% of the diameter of first agitator 1. In an embodiment, the diameter of the third agitator 3 is smaller than the diameter of either first or second agitator 1, 2. In alternate embodiments the diameter of third agitator 3 may be the same as or larger than the diameter of first and second agitators 1, 2. In an embodiment, first and third agitators 1, 3 rotate in the same direction and opposite to that of second agitator 2. In a more preferred embodiment, the first and third agitators 1, 3 have a counterclockwise rotation and the second agitator 2 has a clockwise rotation.

In a preferred embodiment, the agitators 1, 2, 3 are cylindrical brushes having an arcuate surface area for contact with the surface to be cleaned which comprises cleaning bristles. The brushes can be configured with cleaning bristles of conventional size and shape for the desired application. Selection of bristles can be different for each of the three brushes. Bristles are arranged for appropriate lifting and transportation of debris from the surface to be cleaned 100 to the collection means or waste container 7, described below. In another embodiment, the agitators 1, 2, 3 are cylindrical rollers having a plurality of either spaced apart recesses or projections. In another embodiment, the agitators may be bristled-rollers, such as, for example, conventional bristled-rollers. In yet another embodiment, the agitators 1, 2, 3 may be a combination of cylindrical brushes and rollers. For example, first and second agitators 1, 2 may be rollers and third agitator 3 may be a brush, or first agitator 1 may be a roller and second and third agitators 2, 3 may be brushes, or any other permutation thereof suitable for the type and area of the surface to be cleaned.

In FIG. 1, the transport wheels 11, 12 are shown in a retracted position for cleaning a surface 100. As is shown in FIG. 1, and as described in more detail below, when the transport wheels are elevated off of surface 100, the rotating arcuate surfaces of first, second, and third agitators 1, 2, 3 contact the surface 100 and transport debris from the surface 100, into waste container 7. It should be noted, however, that the device is not limited to use with a waste container. In FIG. 2, the transport wheels 11, 12 are shown in the fully extended position, with the wheels resting on the surface 100, for transportation and storage of the cleaning device.

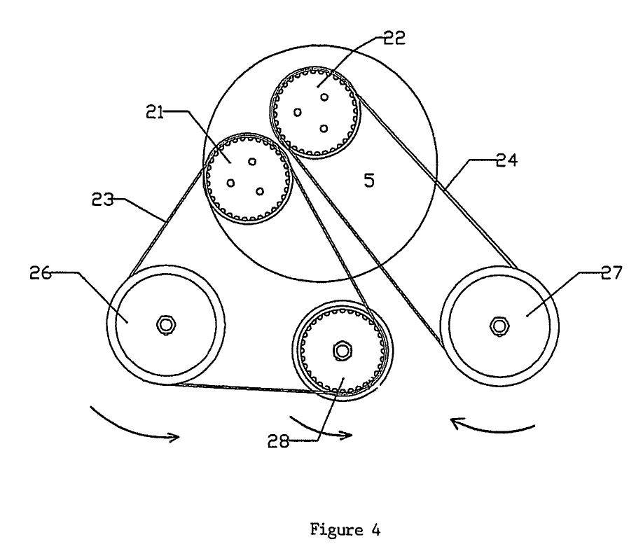

In an example of an embodiment, a drive means is mounted on housing 20 and a power source 4 is enclosed within housing 20. For example, the power source 4 may be an electric motor, an engine, or a drive shaft, preferably flexible. In another embodiment, the power source 4 is remote, for example, a vehicle. Power source 4, although not shown, is operably connected to drive means 5 through a transmission or reduction gears. Referring particularly to FIG. 4, drive means 5 includes a pair of drive gears 21 and 22 mounted to housing 20. Preferably the drive gears are adapted to engage drive belts 23 and 24, respectively. Drive belt 23 is entrained around pulley gears 26 and 28 which are respectively connected to first and third agitators 1, 3. Drive belt 24 is entrained around pulley gear 27 which is operably connected to second agitator 2.

In an example of operation, and as depicted in FIGS. 1 and 2, first agitator 1 is rotated in a counterclockwise direction by transmission and power source 4 and drive belt 23. The invention is contemplated for use with or without chemical cleaning agents. A dispenser 37 is optionally mounted on housing 20. Dispenser 37 may dispense dry or liquid cleaning chemicals onto surface 100. In an example of use, rotation of first agitator 1 scrubs chemicals into the surface being cleaned 100 and transports particles, liquids, wastes, or cleaning powders or solutions to third agitator 3, which functions as a central transporter, while third agitator 3 operates in conjunction with second agitator 2 to transport the waste or debris in a generally upward direction away from the surface 100. Optionally waste or debris is directed into waste container 7, although waste container 7 is not an essential component of the present invention. An example of the flow of debris through the agitators is shown in FIG. 1.

Either the first or second agitator 1, 2 can lead in a direction, making the device bidirectional in operation. Preferably, first agitator 1 is the lead agitator. Additionally, in use, rotation of third agitator 3 may help to propel the device along the surface to be cleaned. In an example of a preferred embodiment, the speed of third agitator 3 ranges from 3% to 20% faster than that of first and second agitators 1, 2, and most preferably is more than 10% faster. For an example of this preferred embodiment, first and second agitators 1, 2 rotate at speeds of about 1.5 meters per second to about 5.5 meters per second, while third agitator 3 rotates at a speed of about 1.7 meters per second to about 7 meters per second. In this example, meters per second is measured from a point on the perimeter of the agitator's surface.

In another example of an embodiment, the speed of third agitator 3 is more than 20% faster than that of first and second agitators 1, 2, and, in yet another example, the speed of third agitator 3 is substantially faster than that of first and second agitators 1, 2.

In alternate embodiments, all agitators rotate at a substantially equal speed. In yet another example of an embodiment, third agitator 3 rotates at a speed that ranges from slightly slower than to substantially slower than that of first and second agitators 1, 2. In still another example of an embodiment of the invention, at least one of agitators 1, 2, 3 is substantially not rotating.

The skilled artisan will appreciate that the speeds of rotation of agitators 1, 2, 3 are determined by at least the intended application, the size of the cleaning machine, and the risk of damage to the surface being cleaned 100. For example, when the device is used to polish a surface, at least of one of agitators 1, 2, 3 may rotate at especially high speeds. Additionally, in production, the device will be fitted with agitators that are of an appropriate diameter for the intended uses of the device. For an example, in production, a machine intended for use to clean a surface such as a street will be fitted with agitators that are adapted to rotate much more slowly than those devices fitted into a machine intended for use to clean a surface such as a wall or an indoor floor covered with carpet.

First, second, and third shrouds 31, 32, 33 are positioned substantially above first, second, and third agitators 1, 2, 3, respectively. In an embodiment, first, second, and third shrouds 31, 32, 33 may be unitary, each shroud having an arcuate recess positioned substantially above one of agitators 1, 2, 3. In another embodiment, shrouds 31, 32, 33 may be separate. In use, first and third arcuate shrouds 31, 33 prevent a buildup of debris on a surface of housing 20 as debris is removed from the surface being cleaned 100. First arcuate shroud 31 may also protect the user of the cleaning device and/or first agitator 1 from injury or damage. Second arcuate shroud 32 directs debris from the surface being cleaned 100 into waste container 7. See FIG. 1.

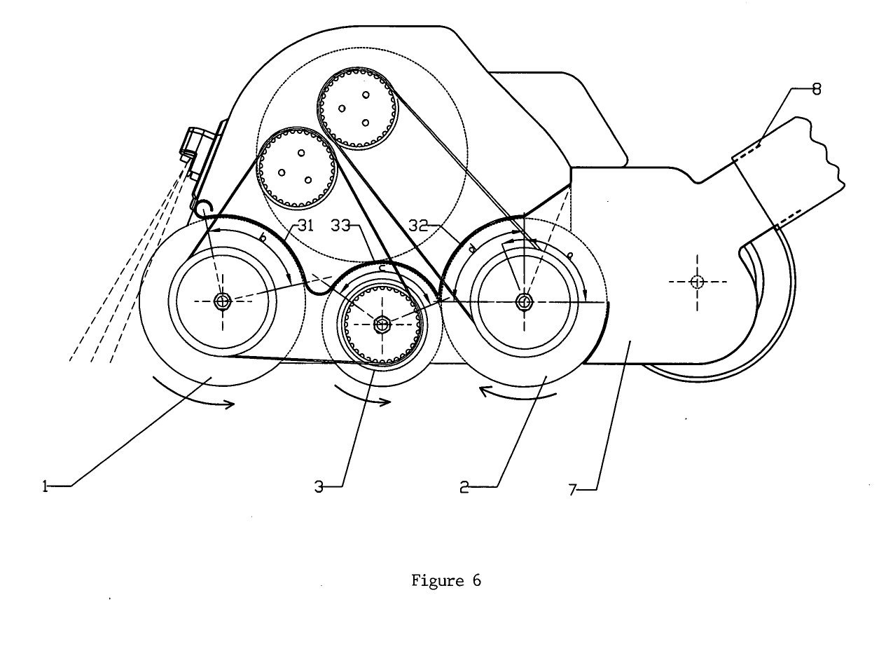

As shown in FIG. 6, and as depicted by angle “b,” in an embodiment, shroud 31 is positioned with a portion measuring substantially above first agitator 1 and encompasses about 90° to 120° of the arcuate surface of agitator 1 extending counterclockwise from the junction between first and third shrouds 31, 33 Third arcuate shroud 33 is positioned substantially above third agitator 3, the recess of arcuate shroud 33 being substantially centered above third agitator 3. Arcuate shroud 33 encompasses approximately 50 to 120° of the arcuate surface on third agitator 3 opposite its contact area. As shown by angle “c” in FIG. 6, third arcuate shroud 33 encompasses about 100° of the arcuate surface on third agitator 3 opposite its contact area. Shroud 33 also directs the debris to the floor in front of third agitator 3. Second arcuate shroud 32 encompasses approximately 75 to 90° of the arcuate surface on second agitator 2 opposite its contact area, as shown by angle “d” in FIG. 6. As shown, second arcuate shroud 32 extends from the end of shroud 33 to waste container 7.

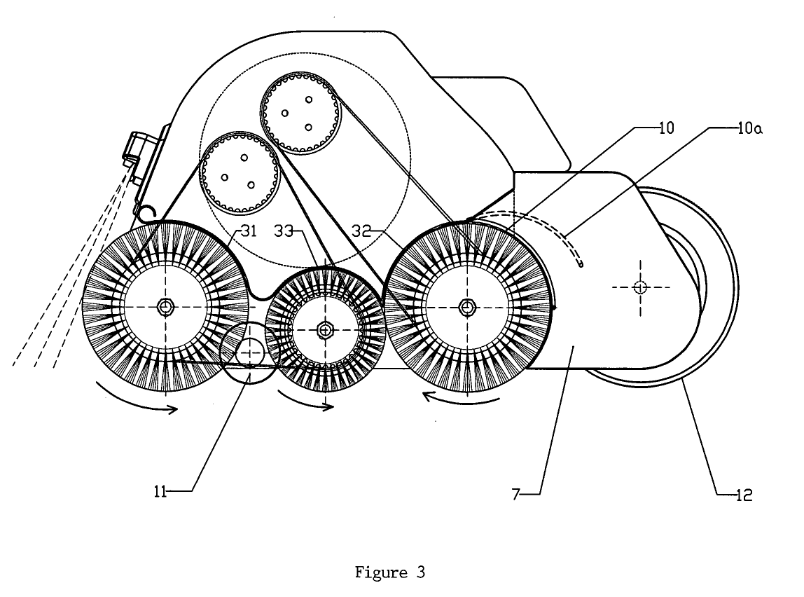

At an end of shroud 32 is an opening or entrance mouth 10 that leads to waste container 7, described below. In an embodiment, lid 10a, as depicted in FIG. 3, may be opened or closed as desired by the user. Cleaning powder or solution can also be agitated onto or into the fibers of the surface being cleaned 100 by agitators 1, 2, 3 and be recycled on the surface being cleaned when lid 10a is closed. In another embodiment, the lid 10a may remain open during operation without the prior or simultaneous use of cleaning chemicals. In this embodiment, soil and debris will be collected in waste container 7, in a pattern similar to that shown in FIG. 1. Although shown as being pivotally attached to an end of shroud 32, in an alternate embodiment, lid 10a may be pivotally attached to waste container 7.

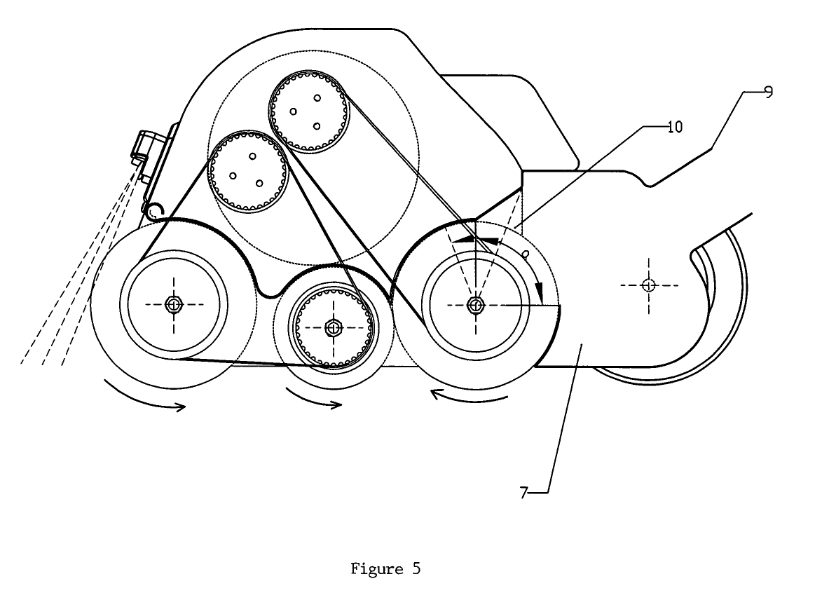

As shown in FIG. 5, opening 10 has an angle “a” that ranges from about 15° counterclockwise from the vertical center of second agitator 2 to about 90° clockwise from the vertical center of second agitator 2. Lid 10a opens or closes to allow or prevent waste and other particles or liquids from entering waste container 7. When lid 10a is in a closed position nothing will be taken off of the surface and waste will simply circulate through the agitators 1, 2, 3 and be redeposited on the surface.

Preferably, second agitator 2 is positioned in substantially close proximity to waste container 7, with a distance between the rotating arcuate surface of second agitator 2 and opening 10 of waste container 7 not exceeding about 2-10% of the diameter of second agitator 2, preferably not exceeding about 5% of the diameter of second agitator 2.

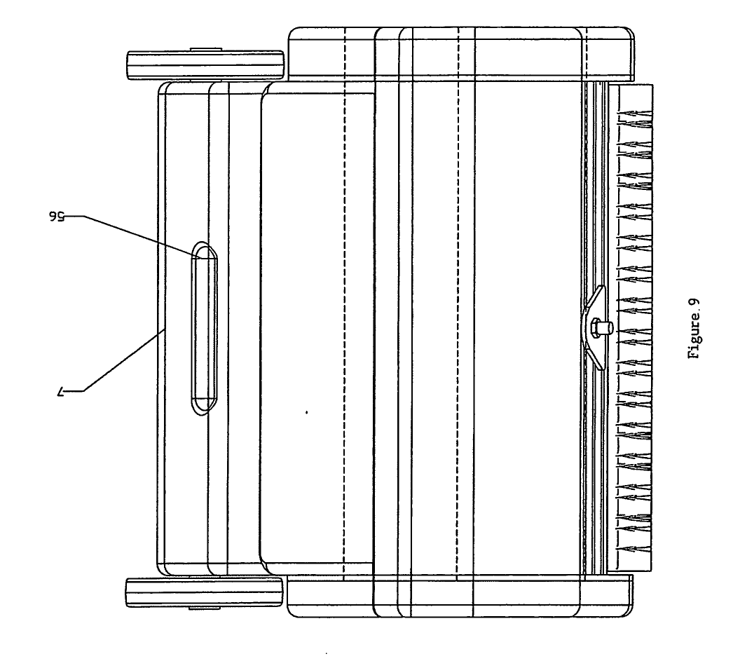

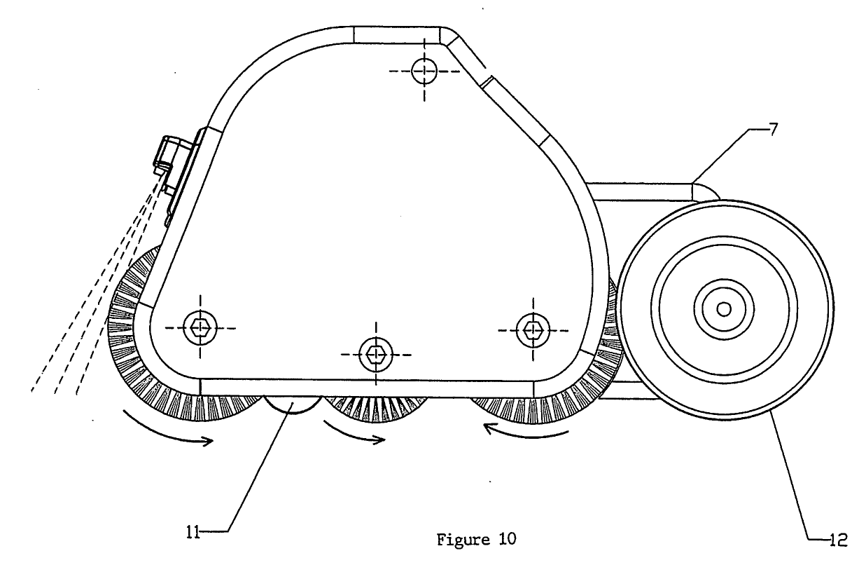

Waste container 7 can be removably hooked on or snapped onto housing 20 or more permanently affixed. Preferably, waste container 7 is located between housing 20 and transport wheels 11, described below. In a preferred embodiment, waste container 7 does not protrude beyond wheels 11. In an alternate embodiment, waste container 7 may protrude beyond wheels 11. An embodiment of the invention in combination with waste container 7 is shown in FIGS. 1-3 and 10. Optionally, waste container 7 may be fitted with a recess grip 56 for easy removal and attachment of waste container 7 to housing 20, as shown in FIG. 9.

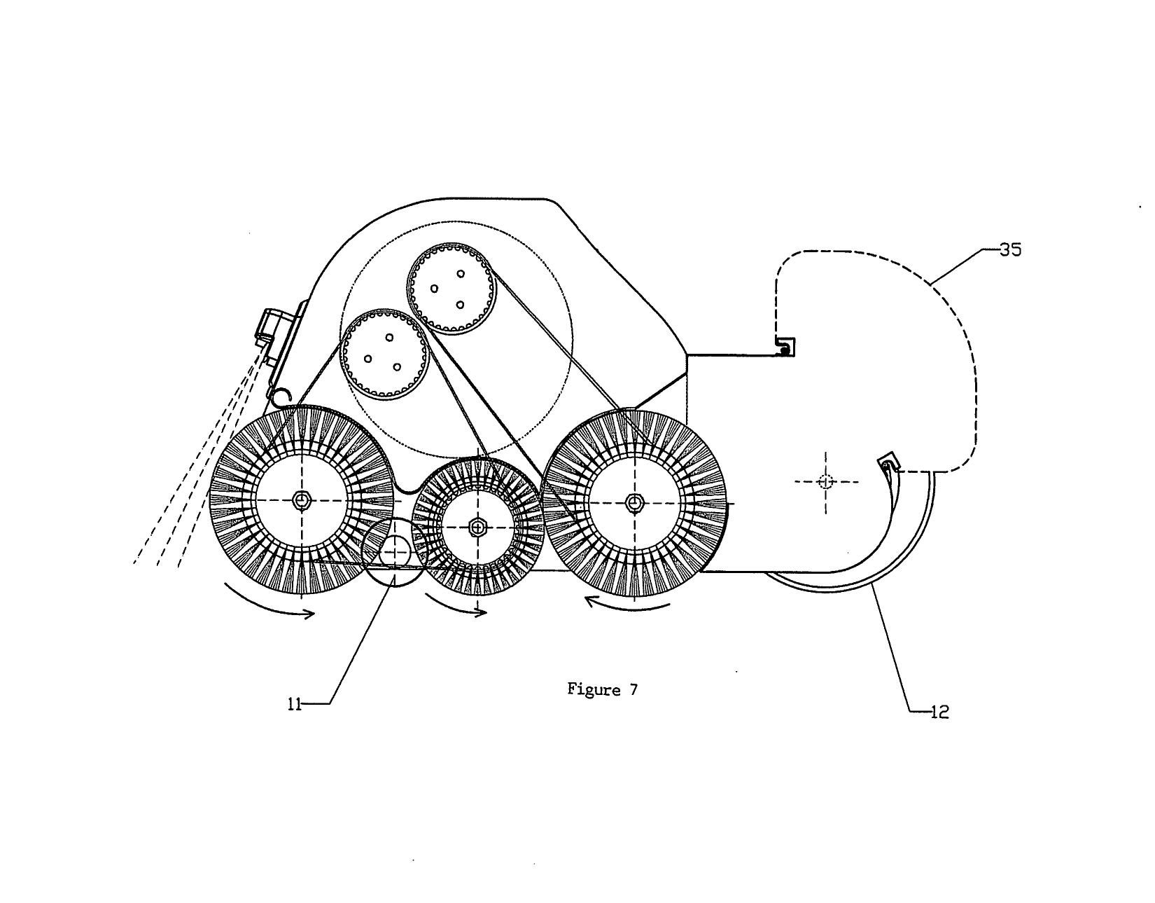

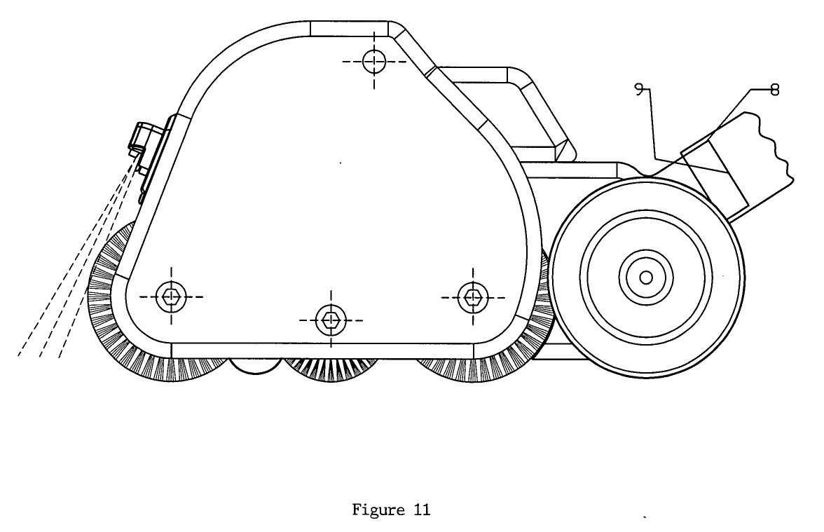

Another example of an embodiment of the device is shown in FIGS. 5 and 11. In these views, a mouth 9 that may be connected to suction is optionally included on waste container 7. As an example, FIG. 6 shows a hose 8 or other removal means attached to mouth 9 so that debris may be suctioned out of waste container 7, such as by a vacuum. Yet another example of an embodiment of the device is shown in FIG. 7, in which a filter bag 35 is used with or in place of waste container 7. Filter bag 35 may be made of a material such as textile screen, although those skilled in the art will recognize that the filter bag may be made from any suitable material. Filter bag 35 may be used to collect dry waste, such as dust, dry cleaning powder, fluff, carpet fiber, sand, and/or metal chips. A special vacuum-nozzle, not shown, can be fitted to conjoin with a vacuum cleaner. It includes a separate machine, or is attached or detachably affixed onto housing 20.

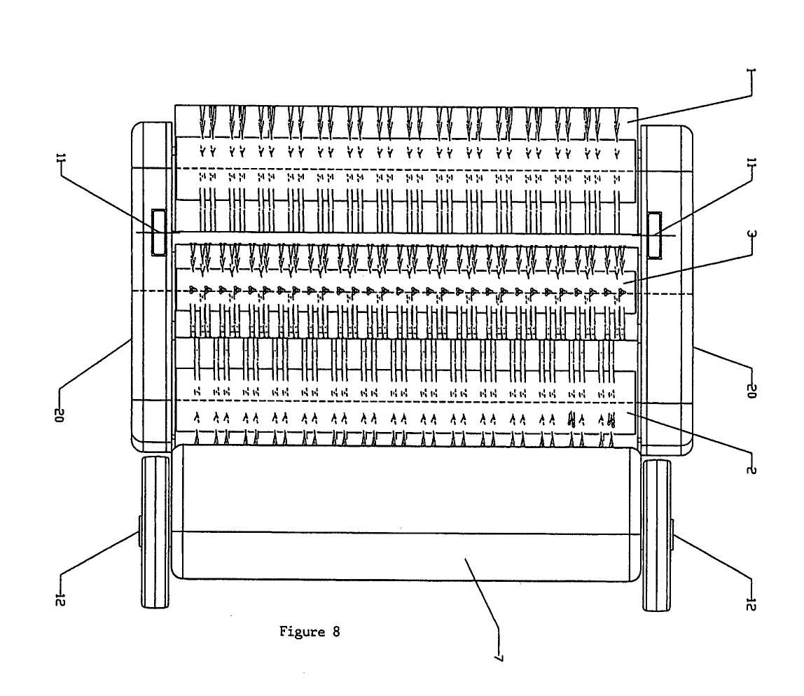

Optionally, transport wheels 11, 12 can be used to support or transport the machine. In an embodiment, transport wheels 11, 12 are wheel sets, as shown in FIG. 8. In an embodiment, wheel set 11 is adjustably retractable and wheel set 12 is fixed to permit raising and lowering the agitators 1, 2, 3 from and to the surface to be cleaned 100. In an alternate embodiment, wheel sets 11, 12 are both adjustably retractable. In a preferred example, wheel set 11 is preferably retracted by adjusting the main handle 6 (partially shown in FIG. 2), or by some other means such as by spring adjusters, a lever, or spindle actuation. The adjustment means may be, for example, manual, electric, or hydraulic, but the skilled artisan will realize that the adjustment means may be operated by any suitable means. In an example, at least one of wheel sets 11, 12 may be retracted so the agitators 1, 2, 3 carry the device and are placed into a working position, as shown in FIG. 1, or the wheel sets 11, 12 may be fully extended to contact the surface so they support the weight of the device during transport, as shown in FIG. 2. Alternatively, at least one of the wheel sets 11, 12 may be adjusted to a mid-point (not shown) so that the wheel sets 11, 12 carry some portion of the device's weight. In addition, first agitator 1 may provide some support for the weight of the device. In another embodiment, transport wheels 11, 12 can be legs, where legs include rubber stoppers, rubber bumpers, at least one kickstand, or any other support means for supporting the device. In an embodiment, legs can be retractable, as described above.

The adjustability of wheel sets 11, 12 accommodates the particular dynamics of a surface, enabling the device to accommodate varying surface terrains and to collect enlarged or irregular waste by altering the distance between the agitators 1, 2, 3 and the surface 100. The adjustment of the wheel sets 11, 12 can elevate the device and lift the agitators from the surface or ensure a constant or uniform clearance between the agitators and the cleaned surface 100. The adjustability of wheel sets protects the surfaces to be cleaned and the agitators and drive mechanism by enabling the device to account for variations in the surface.

Because the preferred configuration of the cleaning device of the present invention has a waste container 7 located between housing 20 and transport wheels 11, the first agitator 1 is free and capable of reaching the edges of the surface to be cleaned, that is, up to a wall. Moreover, opening 10 of waste container 7 is positioned to maximize the volume of the dirt and debris that can be contained during operation.

The device of the present invention may be used to clean a variety of surfaces, including indoor, outdoor, textured, non-textured, horizontal, vertical, and sloped. In comparison to the traditional machines in the prior art, the device is particularly advantageous on coarse surfaces. The surface being cleaned 100 may be made of any type of material, such as but not limited to carpet, concrete, pavement, asphalt, grass, wood, rubber, vinyl, stone, grouted tile, brick, or any combination thereof. The device is not limited to cleaning floors. For example, it may be used to clean escalators and conveyor belts. In an embodiment, the cleaning device may optionally be suspended above the surface to be cleaned, such as where the device is used to clean a conveyor belt. In such an embodiment, the device may remain stationary, being suspended over the conveyor belt, while the conveyor belt is activated to move under the agitators such that the rotating arcuate surface of the agitators 1, 2, 3 contacts the surface 100 of the conveyor belt as the conveyor belt moves under the device to clean the surface. In an alternate embodiment, the cleaning device may be operated on a stationary surface such as a conveyor belt.

The versatility of the device of the present invention derives from the combination of three agitators, which, for example, scrub, remove debris from, and buff the surface to be cleaned.

Various perspective views of the device are shown in FIGS. 8-11.

In an embodiment, the method of using the cleaning device of the present invention for removing debris from a surface comprises the steps of adjusting at least one of the first and second wheels 11, 12 to a retracted position, and placing and suspending the cleaning device over the surface to be cleaned 100 so that agitators 1, 2, 3 move debris in a direction substantially away from the surface, as shown in FIG. 1. The method of use contemplates use of the device wherein the device is placed on the surface to be cleaned 100 and/or wherein the device is suspended over the surface to be cleaned 100, as where the surface to be cleaned is, for example, a conveyor belt such that the cleaning device is moved along a length of the conveyor belt surface to be cleaned so that the arcuate surface areas of agitators 1, 2, 3 come into contact with the surface to be cleaned 100 as agitators 1, 2, 3 rotate.

In another embodiment, the method of using the cleaning device of the present invention for removing debris from a surface comprises the steps of adjusting at least one of wheels 11, 12 to a retracted position, starting power source 4, maintaining the device in a substantially stationary position, and engaging the surface to be cleaned in a direction that is substantially away from surface to be cleaned 100. In examples of embodiments of methods of use, retraction of wheels 11, 12, starting power source 4, and maintaining the device in a substantially stationary position may be carried out in any order, or simultaneously. The method of use contemplates use of the device wherein the device is suspended above the surface to be cleaned 100, as where the surface to be cleaned is, for example, a conveyor belt such that the conveyor belt is activated to move under the activated stationary cleaning device so that arcuate surface areas of agitators 1, 2, 3 come into contact with the surface to be cleaned 100 as agitators 1, 2, 3 rotate.

### EXAMPLES

In one example, the agitators 1, 2, 3 are brushes having bristles. Third agitator-brush 3 has shorter bristles than second agitator-brush 2, the working brush. Preferably, the circumference speed of third agitator-brush 3 is faster than that of second agitator-brush 2. The speed of the agitator-brushes will vary depending upon intended use of the device. For a standard indoor application, the optimum speed of first and second agitator-brushes 1, 2 each having a diameter of about 110 mm, is about 350-550 RPM, and most preferably about 450 rpm, with third agitator-brush 3 rotating at a speed that is preferably more than about 10% faster than that of first and second agitator-brushes 1, 2, although it should be noted that the RPM at which an agitator rotates is relative to the diameter of the agitator. In an example of an embodiment, third agitator 3 rotates at a speed inversely proportional to first and second agitators 1, 2 as a proportion of the diameter of agitators 1, 2 to that of agitator 3.

In one preferred example, the bristles of third agitator 3 are selected to have a length that permits contact or near contact with the bristles of the other agitators, such that third agitator 3 preferably contacts or nearly contacts second agitator 2. In this embodiment, waste recovery is optimum when the clearance between second and third agitators 2, 3 is negligible.

In practice, as an example, the device is used over the surface of a carpet or a hard surface to agitate and/or expel a debris-laden cleaning solution or a powder that has either previously or simultaneously been applied to accomplish chemical and/or mechanical cleaning. The cleaning solution can be any dry or wet conventional chemical solution suitable for the purpose of cleaning. The surface can be an indoor floor, such as tile, stone, wood, or ceramic. In another example of an embodiment of the present invention, the device is used on exterior surfaces, such as concrete, asphalt or pavement, or surfaces having varying topography, such as smooth, uneven or corrugated surfaces, for example, an escalator. The agitators and their diameters are adjusted to advantageously suit the desired surface. In another example, the device is used in conjunction with a street cleaner.

A prototype device in which the agitators were brushes was constructed. A trial was conducted using the following brush diameters and rotational speeds:

| Brush No. | Brush diameter | Brush speed |
|---|---|---|
| First | 110 mm | 460 rpm |
| Second | 110 mm | 460 rpm |
| Third | 80 mm | 650 rpm |

The prototype used two toothed belts 23 and 24, above. First and third agitators 1, 3 operated from the same drive gear 21 to eliminate the need for an additional transmission. Belt tensioners are not needed if an eccentrically positioned bearing housing which houses the gear idler is used on both sides of the housing. This saves weight and costs.

The trial demonstrated the device's effectiveness for picking-up various solid and liquid wastes. It collected washers, nails, sand, cigarette ashes, dirt, and liquid, and deposited the debris into the container.

While the foregoing has been set forth in considerable detail, it is to be understood that the drawings and detailed embodiments are presented for elucidation and not limitation. Design variations, especially in matters of shape, size, and arrangements of parts, may be made but are within the principles of the invention. Those skilled in the art will realize that such changes or modifications of the invention or combinations of elements, variations, equivalents, or improvements therein are still within the scope of the invention as defined in the appended claims.

What is claimed is:

1. A device for removing debris from a surface, comprising:
a housing,
a first and second cylindrical agitator rotatably mounted thereon for rotation in opposing directions, each said first and second agitator having an arcuate surface area, and
a third cylindrical agitator rotatably mounted on said housing for rotation in the same direction as said first agitator and interposed between said first and second agitators, said third agitator having an arcuate surface area,
wherein said second and third agitators are positioned in a substantially close proximity to each other.

2. A device as set forth in claim 1 wherein said arcuate surfaces of each of said first, second and third agitators are operable to contact said surface.

3. A device as set forth in claim 1 wherein said rotation of said first agitator is counterclockwise and said rotation of said second agitator is clockwise.

4. A device as set forth in claim 1 further comprising a power source mounted on said housing or remotely attached to said device through a drive shaft, said source being operatably connected to said agitator for imparting rotation to said agitators.

5. A device as set forth in claim 1 further comprising a container for collecting material transported by said agitators.

6. A device as set forth in claim 5 wherein said container has an adjustable closeable lid for prevention of recovery of debris and cleaning solutions or compounds.

7. A device as set forth in claim 5 wherein said container has a mouth for use in combination with a suction means.

8. A device as set forth in claim 7 wherein said suction means is a vacuum.

9. A device as set forth in claim 1 wherein said agitators are at least one of:
(a) cylindrical brushes;
(b) cylindrical rollers;(c) bristled-rollers;
(d) or any combination thereof.

10. A device as set forth in claim 1 further comprising a shroud, said shroud being positioned substantially above or just above said agitators and having at least one arcuate recess to accept a portion of at least one of said agitators.

11. A device as set forth in claim 10 wherein said shroud is unitary or is comprised of more than one piece.

12. A device as set forth in claim 1 wherein said third agitator rotates at a speed greater than that of said first and second agitators.

13. A device as set forth in claim 1 wherein said first and said second agitators rotate at speeds of about 1.5 to 5.5 meters per second.

14. A device as set forth in claim 1 wherein said third agitator rotates at a speed of about 1.7 to about 7 meters per second.

15. A device as set forth in claim 1 further comprising first and second wheels, said first wheel being removably positioned between said first and third agitators on said housing and said second wheel being removably positioned on said housing by said second agitator and opposite said third agitator.

16. A device as set forth in claim 15 wherein said first and second wheels are each comprised of a set of wheels or legs.

17. A device as set forth in claim 15 wherein at least one of said first and second wheels is retractable.

18. A device as set forth in claim 1 further comprising a handle or a dispenser, said handle or said dispenser being mounted on said housing, said dispenser being capable of dispensing cleaning chemicals or compounds.

19. A device as set forth in claim 1 wherein said surface is:
(a) substantially horizontal;
(b) substantially vertical;
(c) sloped;
(d) substantially textured;
(e) substantially smooth;
(f) or any combination thereof.

20. A device as set forth in claim 1 wherein said surface comprises at least one of:
(a) carpet;
(b) floor;
(c) floor coverings;
(d) concrete;
(e) pavement;
(f) asphalt;
(g) rubber;
(h) wood;
(i) vinyl;
(j) brick;
(k) stone;
(m) grouted tile;
(n) a conveyor;
(o) an escalator;
(p) or a combination thereof.

21. A device as set forth in claim 1 wherein said device is positioned on or suspended above said surface to be cleaned.

22. A device as set forth in claim 1 wherein said third agitator has a diameter smaller than, larger than, or substantially the same as a diameter of said first and second agitators.

23. A method of using a device as claimed in claim 15 for removing debris from a surface, comprising the following steps:
a. adjusting at least one of said first and second wheels to a retracted position; and
b. placing or suspending said device on or over said surface, said agitators moving said debris in a direction substantially away from said surface,
wherein steps a and b can be performed simultaneously or sequentially in any order.

24. A method of using a device as claimed in claim 15 for removing debris from a surface, comprising the following steps:
a. adjusting at least one of said first and second wheels to a retracted position;
b. maintaining said device in a substantially stationary position; and
c. engaging said surface to move in a direction, said agitators moving said debris in a direction substantially away from said surface,
wherein steps a, b, and c can be performed simultaneously or sequentially in any order.
